(19) United States
(12) Patent Application Publication
(10) Pub. No.: US 2008/0286513 A1
(43) Pub. Date: Nov. 20, 2008

(54) KNIT FABRICS AND SOCKS MADE THEREFROM INCORPORATING HIGH TENSILE NYLON STAPLE

(75) Inventors: John R. Haigh, Elon, NC (US); Michael Profit, Wilmington, DE (US); Gregory Paul Weeks, Hockessin, DE (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S A R L, Wilmington, DE (US)

(21) Appl. No.: 11/748,681

(22) Filed: May 15, 2007

(51) Int. Cl. B32B 1/08; D04B 1/00; D04B 1/18

(52) U.S. Cl. 428/36.3; 442/304; 442/306

(57) ABSTRACT

Knit fabrics and socks made therefrom and a process for producing such articles are disclosed, The fabrics are constructed from blended yarns containing at least 30% by weight high tensile nylon, which imparts abrasion resistance, and at least one companion fiber, which is chosen to confer a specific desirable attribute. Exemplary is the fabric constructed from blended yarn containing high tensile nylon staple and polyester staple, the fabric being particularly useful for the manufacture of socks demonstrating improved durability and moisture management.

### BACKGROUND OF THE INVENTION

1. Field of the Invention

This present invention relates to socks and other leg wear made from knit fabric constructions that incorporate high tensile strength nylon staple in combination with other companion fibers, and to methods for manufacture of these fabrics and socks and leg wear made therefrom.

2. Background of the Invention

The use of polyester, cotton, wool and acrylic staple fibers for making yarns intended for knitting of leg wear and socks is well known. Further, the production of staple/staple blend yarns is well known for the manufacture of leg wear and socks. The choice of fiber or fibers is dictated by a number of requirements including comfort, fit, absorbency and durability and aesthetics. Fiber blends that have been employed to meet a variety of such requirements include cotton/polyester blends, and blends of various polyester types, colors, and deniers. Polyester filament or staple COOLMAX® 729W manufactured by INVISTA S.à. r.l. and Sensura® fiber manufactured by Wellman, Inc. are examples of polyester fibers particularly useful for moisture management, keeping the wearer's feet cool and dry. Blends of nylon and cotton are known for military outerwear, but not commonly known for sock applications.

Potential added value for socks and other leg wear could be derived from an improvement in durability. As used in this application durability refers to sock fabrics that are characterized by high resistance to abrasion, pilling, cuts and tears. Methods for improving the durability of socks have included the use of reinforcing panels or reinforced construction of areas of high wear, such as the heel and toe. One method used for achieving improved durability in women's hosiery made by circular knitting is to terminate the toe portion of the seamless tube with a relatively wide band of courses of heavier or additional reinforcing threads. U.S. Pat. No. 2,699,056 illustrates such a type of reinforcement U.S. Pat. No. 4,037,436 describes an alternative reinforced toe construction that features a less prominent band of reinforcement that is limited to the greatest points of wear at the ends and sides of the toe extremities. While offering improved durability, these methods require a separate manufacturing step and only provide reinforcement to a localized area.

High tensile strength nylon has been used in heavyweight fabrics for rugged use products such as backpacks, luggage, and footwear, all of which require resistance to abrasion, cuts, and tears. The high durability products used in these applications are generally of woven construction from heavy denier nylon filament. Fabrics made for these types of applications, while exhibiting remarkable resistance to wear and tear, are not suitable for socks where direct skin contact demands a soft feel and high bulk is desirable for cushioning and resilience. High tensile nylon fabrics have been made in lighter weight versions for apparel outerwear applications. The use of high tensile nylon in socks has, until the present, been limited to its incorporation, in continuous filament form, into selected areas of the sock. While this does result in wear resistance in localized areas of the sock, it also adds to the complexity of the manufacturing process.

As disclosed by Thompson in U.S. Pat. No. 5,011,645, high tensile nylon staple fiber can be made by melt-spinning nylon polymer into filaments; collecting very large numbers of these filaments into a tow, which usually contains many thousands of filaments and is generally of the order of several hundred thousand in total denier; and then subjecting the continuous tow to a drawing operation between a set of feed rolls and a set of draw rolls (operating at a higher speed) to increase the orientation in the filaments; followed by a heating and subsequent cooling operation (collectively referred to as “annealing”) to increase the crystallinity while maintaining the drawn tow under a controlled tension; and finally converting the cooled tow to staple, e g. in a staple cutter. Nylon staple made in this fashion exhibits tensile strengths in the range T=6.5-7.0 gpd. As used in this application T refers to the load at failure. One of the advantages of staple fibers is that they are readily blended, particularly with natural fibers, such as cotton (often referred to as a short staple) and/or with other synthetic fibers, to achieve the advantages derivable from blending. High tensile nylon may be prepared by a method similar to that described by Thompson, but in filament rather than tow form, and various texturing operations may be optionally conducted on the filaments at some point subsequent to the annealing stage. One such commercially available fiber is sold under the CORDURA® brand (INVISTA S.à r.l.).

In U.S. Pat. Nos. 3,044,250, 3,188,790, 3,321,448 and 3,459,845, Hebeler has disclosed the use of high tensile nylon staple of a type similar to that described by Thompson in blends with other textile fibers, particularly high-modulus natural or naturally-derived cellulosic-based staple fibers. Hebeler reported achieving greater tensile strength in the blended yarn (vs. the companion staple fiber) and imparting improved abrasion resistance to the textile fabric prepared therefrom. However, the use of these textile fabrics for socks was not reported.

Blends of high tensile nylon staple with polyester, cotton, wool, and acrylic staple are not commonly practiced in any form of sock applications. It would be advantageous to provide socks and leg wear with improved durability throughout the sock, not just in localized areas, as well as to provide a method for economic manufacture on commercially available circular knitting machines. It would be of further advantage to provide blends of high tensile nylon with companion fibers such that the resulting sock fabric demonstrates moisture wicking properties adequate to keep the wearer's feet dry.

### SUMMARY OF THE INVENTION

In one embodiment, a knit fabric containing at least 30% by weight of high tensile nylon staple in combination with one or more companion fibers is used to manufacture a sock with improved durability, and more specifically, increased resistance to abrasion. Companion fibers that may be used in the construction of this fabric include cotton, polyester, acrylic, wool, polyolefin, and combinations thereof. Using the fabric of this invention a sock of circular knit construction may be manufactured featuring a plain knit, rib knit, terry knit (full or partial cushion), or jacquard knit.

In another embodiment, the companion fibers used in combination with the high tensile nylon staple are chosen so as to provide socks not only with improved abrasion resistance, but with certain other desired attributes provided by the respective companion fibers. Such other desirable attributes may include: adsorption and wicking (for moisture management), bulk (for cushioning and resilience) and softness. Fabrics knit from blended yarns comprising high tensile nylon staple and such companion fibers provide the characteristics attributable to the companion fibers without any deleterious effect resulting from incorporation of the high tensile nylon staple.

In a further embodiment the knit fabric from which socks may be constructed contains a blend of high tensile nylon staple and a moisture-wicking polyester fiber. Knit fabrics made from a blended yarn of these fibers will provide both excellent abrasion resistance and moisture control. High tensile nylon staple useful in the production of the socks of the invention are known in the art and include, for example, CORDURA® branded staple which is commercially available from INVISTA. Moisture-wicking yarns useful in the production of the socks of the invention are known in the art and include, for example, Coolmax® brand yarns which are commercially available from INVISTA. Such yarns are known to exhibit unique cross-sections that contribute to their wicking ability. The moisture-wicking yarns blended from high tensile nylon staple and polyester fiber may be used alone or with other fibers or yarns in the preparation of the fabrics and socks of some embodiments.

In another embodiment of the socks of this invention, the leg section of the sock includes elastomeric yarn. The elastomeric yarn, in contrast to the companion fibers of this invention, are typically present in an amount of 0.5% to about 5% by weight, based on the total weight of the sock. The elastomeric yarn can be present in one or more of the other various regions or sections of the sock as well. Including elastomeric yarn in the leg section of the sock can provide stretchability as well as allow the leg section to resiliently engage the leg of the wearer and keep the leg section in place. Elastomeric yarns useful in the production of the socks of the invention are known in the art and include, for example, LYCRA® yarns which are commercially available from INVISTA.

### DESCRIPTION OF THE DRAWINGS

FIG. 1 illustrates abrasion test results, at 15,000 and 45,000 cycles of testing, obtained on duplicate samples of fabrics made with 50/50 high tensile nylon staple/cotton blended yarn made by the present invention vs. duplicate samples made with a non-blended cotton yarn.

FIG. 2 illustrates the abrasion test results obtained of fabrics made with non-blended polyester staple yarn after 50,000 cycles of testing.

FIG. 3 illustrates the abrasion test results obtained on fabrics made with 50/50 high tensile nylon staple/polyester blended yarn after 150,000 cycles.

FIG. 4 illustrates abrasion test results obtained, after 100,000 cycles of testing, on fabric made with polyester staple yarn reinforced on the outside face of the by high tensile nylon filament yarn vs. fabrics made with a 50/50 high tensile nylon staple/polyester staple.

FIG. 5 illustrates the abrasion test results obtained, after 200,000 cycles of testing, on the same 50/50 high tensile nylon staple/polyester staple sample as shown in FIG. 4.

### DETAILED DESCRIPTION OF THE INVENTION

Blends of high tensile nylon staple with certain companion fibers or with combinations of companion fibers have been found to provide knit fabrics, particularly suitable for the manufacture of circular knit socks, with surprisingly useful combinations of properties heretofore not recognized in the sock manufacturing trade. These useful and valuable properties are observed provided the nylon staple employed is incorporated into the knit fabric at a level of at least 30% by weight of the fabric and the tensile strength of the preferred nylon 6,6 is in the range of T=6.5-7.0 grams per denier (gpd). Such high tensile strengths are achievable by employing a high draw ratio, as described in the following paragraph, and compare to tensile strengths in the range of 4.5-5 gpd for standard nylon 6,6 yarns.

The high tensile nylon staple suitable for this invention is derived from nylon filament characterized by both a high degree of crystallinity and a high degree of crystalline orientation. These high tensile filaments are formed by drawing them to the substantially maximum operable draw ratio and subjecting them to a heat treatment under drawing tension. Such filament and the staple from which it is derived are commercially produced by processes similar to those described in the aforementioned patents of Hebeler and Thompson, as well as similar methods of manufacture in which filament rather than tow is processed. Suitable nylon polymers are the linear polyamides, such as polyhexamethylene adipamide (nylon 6,6) and polycaproamide (nylon 6). Crystallizable polyamide copolymers are also suitable when 85% or more nylon 6,6, or nylon 6 component is present. The preferred nylon of this invention is nylon 6,6, staple and a particularly suitable example of that is T420 CORDURA® yarn, commercially available from INVISTA. As demonstrated on the examples below, the incorporation of this type of nylon staple yarn into the knit sock fabric at levels falling within the range of 30-50% by weight improves the abrasion resistance of socks by a minimum factor of at least two times (2×), and optionally up to three times (3×) or more, while providing a significant improvement in resistance to pilling. Unexpectedly, this improvement in durability is realized without significantly affecting the softness of the fabric. The blended yarn also retains high bulk contributing to the comfort experienced by the wearer.

Depending upon the performance requirements that are specified for the sock or leg wear, a variety of companion yarns or blends of companion yarns may be knit into the sock fabric along with the high tensile nylon staple yarn. Such companion yarns may be synthetic or natural and include cotton, polyester, acrylic, wool and polyolefin.

In one particular embodiment described in detail in the following examples, a knit fabric sock construction is manufactured from a 50/50 blend of high tensile nylon staple and polyester in either staple or filament form. Particularly suitable examples of polyester staple yarn that can impart high moisture wicking capacity to sock fabrics are sold under the COOLMAX® brand name available from INVISTA. Socks sold under the COOLMAX® brand name are required to pass strict moisture management criteria to meet brand requirements. As demonstrated in the following examples, high tensile nylon staple can represent a substantial proportion of the sock fabric with the fabric still meeting these moisture management specifications. In fact, an unanticipated result is the improvement in the wicking of ability of the polyester-containing fabrics when blended with the high tensile nylon staple.

The preferred range of physical characteristics of the nylon staple and the companion fibers of this invention are 1.0-3.0 denier per filament (dpf) and a staple length (for either nylon or companion fiber) of 1.0-3.0 inches. It is preferred that at least the nylon staple, and optionally the companion fiber (if employed as staple) exhibit some degree of texturing or crimp.

The preferred crimp frequency for the high tensile nylon staple of this invention is greater than 25 crimps per inch (crimp frequency is defined herein as the number of full waves, crimps, or non-linear kinks, measured by holding the filament in a semi-relaxed configuration under a magnifier sufficient to observe the crimp and dividing by the straightened length), and more preferably greater than 50 crimps per inch Companion fiber staple crimp frequency is preferably less than 25 crimps per inch. Texturing may be achieved by any number of commercially known processes including false twist texturing, stuffer box texturing and air jet texturing. Other texturing techniques are known to those skilled in textile processing and may be alternatively employed. While not wishing to be bound by any particular theory, it is believed that the textured characteristics of the staple results in increased fiber entanglement making it more difficult to pull the staple apart and resulting in a more cohesive yarn. It is further believed that the more cohesive nature of the yarn minimizes breaches of the knit structure of the sock fabric which would otherwise lead to an acceleration of fabric failure via abrasion.

Nylon and companion fiber staple may be blended and spun into yarn, from which the socks described in this invention may be economically produced on conventional circular knitting machines commonly used to manufacture leg wear.

The following examples illustrate but do not limit the invention. The particularly advantageous features of the invention may be seen in contrast to the comparative examples, which do not possess the distinguishing characteristics of the invention.

### EXAMPLES

### Sample Preparation

A description of the fabric contents, yarn constructions, and manufacturing processes for the various sock fabrics evaluated in the examples to be presented are provided below and also summarized in Table 1.

(a) Yarn Construction and Manufacture

Blended yarns of high tensile nylon staple with companion polyester or cotton staple were each used in the body of the socks of the current invention which are the subject of the evaluations described in the following examples. Comparative examples were obtained with socks made from (i) polyester staple yarns, (ii) cotton staple yarns, and (iii) polyester staple yarns with reinforcing high tensile nylon filament yarns. Staple yarns were made by use of a conventional ring spinning process. For the blended staple yarns, the staple constituents were mixed prior to the yarn spinning operation.

The high tensile nylon staple used was Type T420, semi-dull, round cross-section, sold under the CORDURA® brand (INVISTA). The polyester staple used was Type 729W, semi-dull tetra channel cross-section, sold under the COOLMAX® brand (INVISTA) Both types of staple were 1.7 denier per filament with a cut length of 1.5 inches.

LYCRA® brand spandex filament (Type 902C, available from INVISTA) double covered with nylon filament (TACTEL® brand available from INVISTA), chosen for its soft, comfortable feel, was also incorporated in the sock top, and a finer count spandex, T-162B LYCRA® spandex, was incorporated throughout the sock, as described in the following section of sock construction and manufacture.

(b) Sock Construction

The test results reported in the following examples were obtained on fabric from knitted ankle socks. The body of these socks employed a plated construction such that the covered spandex was positioned within the fabric structure and shielded from both the face and the back side of the fabric. Construction details were as follows:
1. Sock top. 120 denier LYCRA® spandex (Type 902C, available from INVISTA) double covered with 70 denier/34 filament and 40 denier/13 filament TACTEL® nylon (available from INVISTA) and 20 denier LYCRA® air jet covered by 2 ply of 70 denier/68 filament TACTEL®.
2. Sock body—Non Elastification Yarns: Blended staple yarns of high tensile nylon staple with either polyester staple or cotton were used to demonstrate the performance of socks made according to the present invention. Sock bodies were also constructed with other types of yarns for the purpose of obtaining comparative sock evaluations. The characteristics of all these yarns are summarized in Table 1.
3. Sock body—Elastification Yarns: 20 denier LYCRA® air jet covered by 2 ply of 70 denier/68 filament TACTEL®.

(c) Sock Manufacture

Sock fabrics described in the following examples were manufactured on a Lonati Model L454JR circular knitting machine with 108 needles and a 4 inch diameter cylinder diameter.

### Example 1

Socks with constructions as described in the Sample Preparation section above were made by circular knitting.

Abrasion testing was conducted on the sock body fabric according to ASTM D4966, commonly referred to as the Martindale Abrasion Test. The principle of the test is that the specimen fabric is rubbed against a standard abradant fabric (a specially woven worsted fabric). The abrading motion is in the form of a straight line which becomes a gradually widening ellipse, until it forms another straight line in the opposite direction and traces the same figure again under known conditions of pressure and abrasive action. The measure of abrasion resistance is the number of cycles to fabric failure.

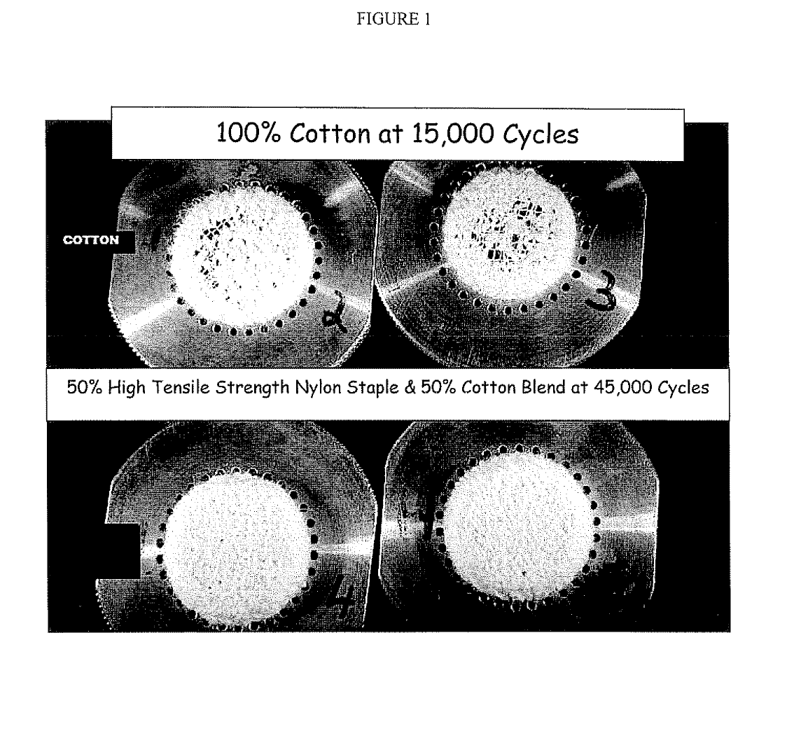

FIG. 1 compares the abrasion resistance of duplicate samples of sock fabrics made with 50/50 high tensile nylon staple/cotton blend yarn made by the present invention vs. duplicate samples made with a non-blended cotton yarn. The cotton sock fabric has failed at 15,000 cycles while the nylon/cotton blend fabric exhibits little wear.

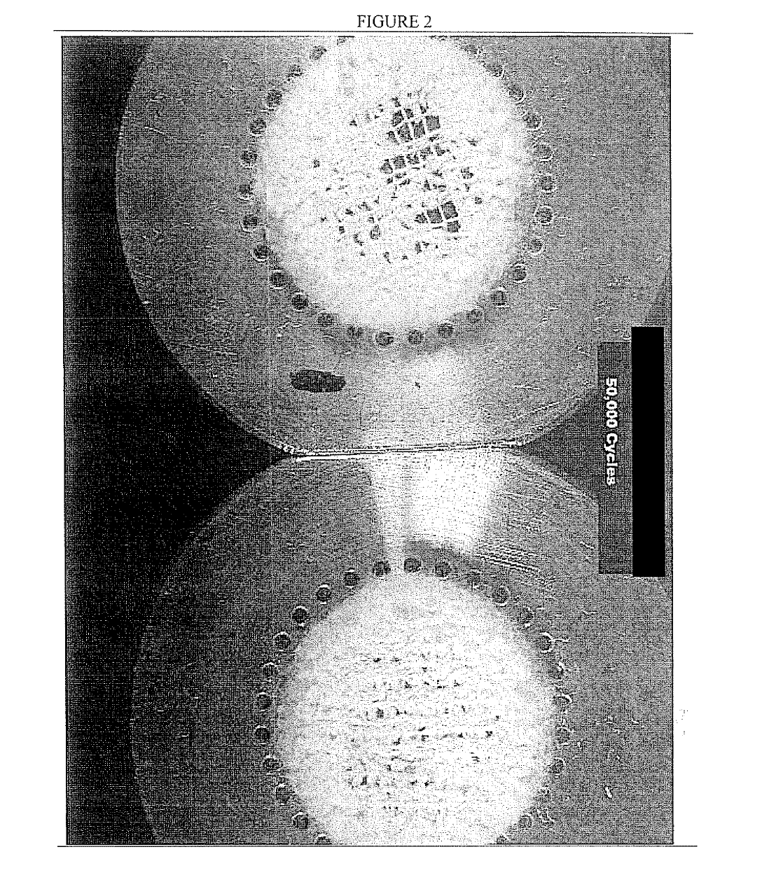

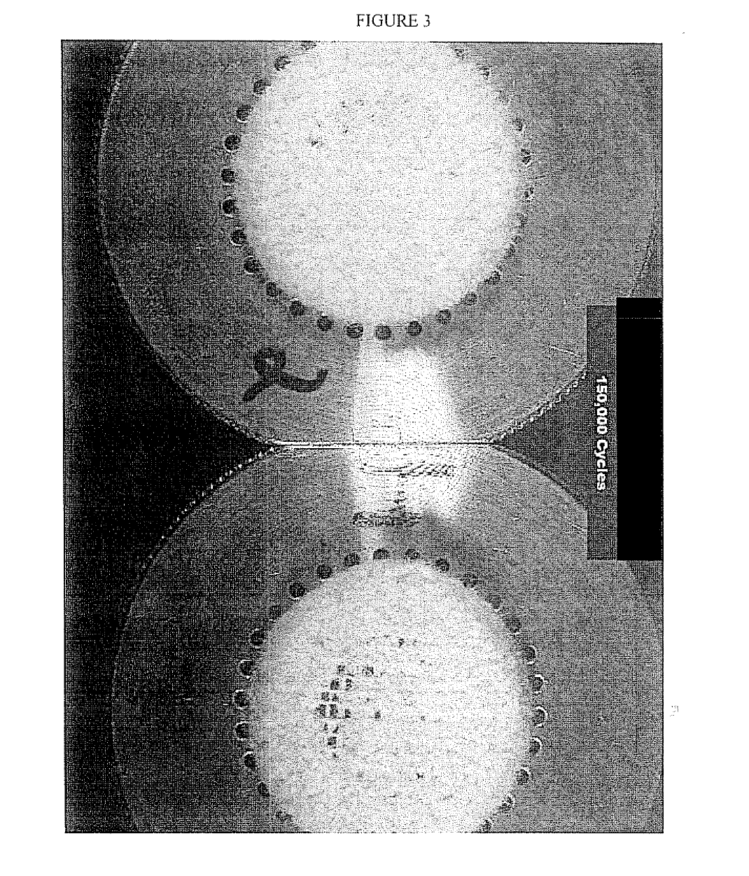

FIGS. 2 and 3 compare the respective abrasion resistance of sock fabrics made with non-blended polyester staple yarn and blended yarns made from 50/50 high tensile nylon staple/polyester staple. At 50,000 cycles the unblended polyester fabric has failed while the nylon/fabric blend of the present invention is only just approaching failure at 150,000 cycles.

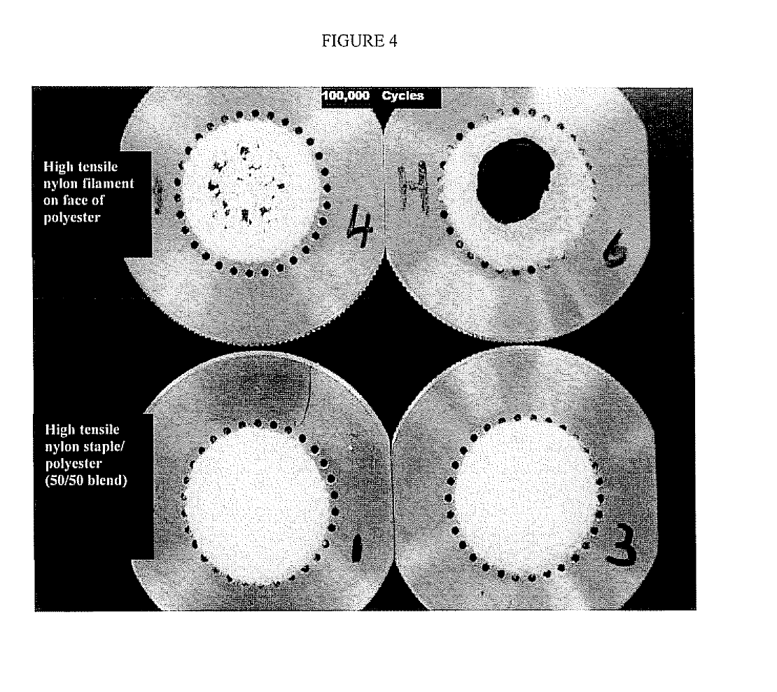

FIG. 4 compares the abrasion resistance of sock fabric made with polyester staple yarn reinforced on the outside face of the sock by high tensile nylon filament plating yarn vs. sock fabrics made with a 50/50 high tensile nylon staple/polyester staple. At 100,000 cycles the nylon/polyester staple blend of the present invention shows no obvious signs of wear while the high tensile nylon filament reinforced polyester staple yarn has failed. This result clearly demonstrates the superior abrasion resistance imparted to sock fabrics by high tensile nylon when employed in its staple vs. filament form. This observation is somewhat surprising in view of the fact that the high tensile nylon filament is successfully used in other woven fabric applications where resistance to abrasion, cuts and tears is required. It is believed that the blending of staple, where at least one type of staple exhibits texturing, results in a bulkier, more cohesive yarn consequently leading to a knit structure that is much more resistant to being spread apart and damaged.

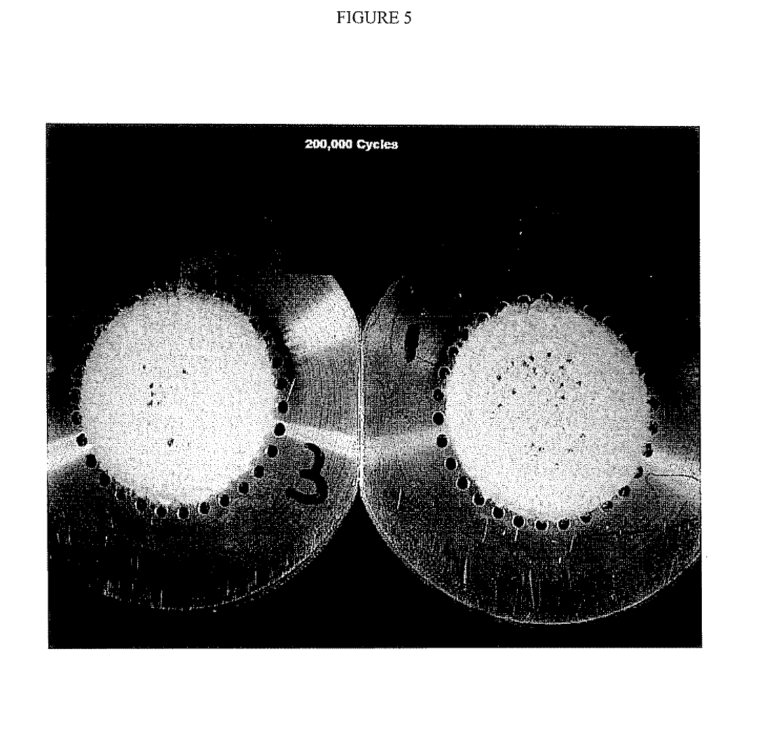

FIG. 5 shows the same (as in FIG. 4) nylon/polyester staple blend sock fabric after 200,000 cycles of abrasion testing. The fabric still appears serviceable, although indications of incipient failure are observed.

The results of this example clearly demonstrate the substantial improvement in abrasion resistance that is imparted to sock fabrics when high tensile staple is incorporated into the yarn from which the sock fabrics are knit.

### Example 2

Socks with constructions as described above were tested for pilling resistance according to ASTM 3512. Pilling and other changes in surface appearance, such as fuzzing, that occur in normal wear are simulated on a laboratory testing machine. Pills are caused to form on fabric by a random rubbing action produced by tumbling specimens in a cylindrical test chamber lined with mildly abrasive material. To form pills with appearance and structure that resemble those produced in actual wear, small amounts of short-length gray cotton fibers are added to each test chamber with the specimens. The degree of fabric pilling is evaluated by comparison of the tested specimens with visual standards that may be photographs of fabrics showing a range of pilling resistance. The observed resistance to pilling is reported using a rating scale that ranges from 5 (no pilling) to 1 (very severe pilling).

Table 2 summarizes the pilling ratings for the sock body fabrics made with polyester staple and with 50/50 high tensile nylon staple/polyester staple blends. The cotton count (a yarn numbering system based on the mass per standard length; the higher the number the finer the yarn) of each type of yarn was equivalent. Polyester staple yarn was tested as both 1 ply and 2 ply construction. The pilling resistance of socks made from the high tensile nylon staple/polyester staple blends of the present invention was clearly superior to the unblended polyester staple, consistent with the abrasion results of Example 1.

The softness to touch of the high tensile nylon staple/polyester staple blend sock was rated equivalent by an expert panel.

### Example 3

Pilling resistance tests according to the ASTM 3512 procedure described in Example 2 were conducted on polyester staple and on 50/50 high tensile nylon staple/polyester staple blends, but in this case both fabrics were made with a 1 ply finer yarn. Results are summarized in Table 3. With this different fabric construction severe pilling is observed for both the polyester staple and the polyester/high tensile nylon staple blends for extended periods of testing. However, at short testing times the socks made from the blended yarn demonstrate dramatically improved performance.

### Example 4

Moisture management performance was evaluated for socks made with unblended polyester staple yarn vs. blended yarns of 50/50 high tensile nylon staple/polyester staple. The yarn and sock constructions were as described in the Sample Preparation section above. In both types of socks, the polyester staple employed was Type 729W COOLMAX® brand (INVISTA), a polyester commonly used in socks because of its excellent absorbency and wicking ability.

The standard test method for evaluating the moisture management properties of the sock is the measurement of vertical wicking, conducted as follows.

A fabric strip is cut from the body of a sock and hung vertically with a clamp. The free end is dipped into distilled water to a specified depth for a specified time. The height of the water that wicks upward through the fabric strip is measured and recorded.

The results of these measurements are summarized in Table 4. Results were obtained on each type of sock fabric from both boarded (a process carried under heat to confer the desired shape) and un-boarded socks. The relative difference in performance for the boarded and unboarded fabrics of each type was qualitatively similar. The wicking ability of the high tensile nylon staple/polyester staple blend fabrics exceeded that of the unblended polyester staple fabric. Thus, improvement of the wicking ability of socks made from a polyester staple yarn that is known and used for its excellent moisture management attributes was actually achieved by diluting the polyester staple content of the yarn with high tensile nylon staple. This was a totally unanticipated result and, in combination with the improved abrasion resistance, offers the consumer a sock with significant performance advantages, especially in active wear applications.

### Example 5

Moisture wicking tests according to the procedure described in Example 4 were conducted on polyester staple and with 50/50 high tensile nylon staple/polyester staple blends, but in this case both fabrics were made with a 1 ply finer yarn While fabrics made from both types of yarn transported moisture to 5 inches of vertical height well within the duration of the test, the fabric made with the blended yarn showed a significantly higher rate of moisture transport to that height.

The above embodiments have been described by way of example only. Many other embodiments of the invention falling within the scope of the accompany claims will be apparent to the skilled reader.

1. An article comprising a fabric comprising a blended yarn having
(a) at least about 30% by weight high tensile nylon staple; and
(b) at least one companion fiber comprising moisture wicking polyester;
wherein said fabric is in the form of a sock having a knit construction.

2. The article of claim 1, wherein said blended staple yarn is present in selected locations of said article.

3. The article of claim 1, wherein said blended staple is present throughout said article.

4. The article of claim 1, wherein said fabric comprises the combination of said blended staple yarn and at least one companion yarn.

5. The article of claim 1, wherein said fabric comprises the combination of said blended staple yarn and at least one companion continuous fiber.

6. The article of claim 4, wherein said fabric comprises a greater amount of said blended staple yarn compared to said companion yarn.

7. The article of claim 5, wherein said fabric comprises a greater amount of said blended staple yarn compared to said companion continuous fiber.

8. The article of claim 1, wherein said companion fiber comprises at least one member selected from the group consisting of cotton, polyester, acrylic, wool, polyolefin, and combinations thereof.

9. The article of claim 1, wherein said companion fiber comprises a staple fiber.

10. The article of claim 1, wherein said fabric comprises a circular knit construction.

11. The article of claim 1, wherein said fabric comprises a construction selected from plain knit, rib knit and jacquard knit.

12. The article of claim 1 further comprising an elastic fiber.

13. The article of claim 12, wherein said elastic fiber comprises a fiber selected from spandex, polyester bicomponent, and combinations thereof.

14. The article of claim 1, wherein said sock is selected from a construction including a heel pocket or a tube construction.

15. (canceled)

16. The article of claim 1, wherein said blended yarn includes from about 30% by weight to about 70% high tensile nylon staple.

17. The article of claim 1, wherein the blended yarn comprising said fabric comprises a ratio of approximately a 50/50 blend by weight of said high tensile nylon staple and said companion fiber.

18. The article of claim 1, further comprising high tensile nylon filament in at least one of a heel portion and a toe portion of said sock.

19. The article of claim 1, wherein said high tensile nylon staple comprises nylon 66.

20. A method for providing an abrasion resistant sock comprising
knitting a sock with a blended yarn comprising
(a) at least 30% by weight of high tensile nylon staple;
(b) and at least one companion fiber comprising moisture-wicking polyester.

21. An article comprising a fabric comprising a blended yarn containing:
(a) at least about 30% by weight high tensile nylon staple; and
(b) at least one companion fiber comprising moisture-wicking polyester;
wherein said fabric is in the form of a sock having a knit construction comprising a circular knit construction selected from plain knit, rib knit and jacquard knit.

22. The article of claim 21 further comprising at least one elastic fiber.

23. An article comprising a knit fabric comprising a blended yarn containing
(a) at least about 30% by weight high tensile nylon staple; and
(b) at least one companion fiber comprising moisture-wicking polyester.

24. An article comprising a fabric comprising a combination of a blended yarn and at least one companion yarn; wherein said blended yarn comprises:
(a) at least about 30% by weight high tensile nylon staple; and
(b) at least one companion fiber;
said companion yarn comprising at least one member selected from the group consisting of cotton, polyester, acrylic, wool, polyolefin, and combinations thereof; and
said fabric is in the form of a sock having a knit construction.
